(19) United States
(12) Patent Application Publication
(10) Pub. No.: US 2017/0011564 A1
(43) Pub. Date: Jan. 12, 2017

(54) CUTTING BIT MONITORING SYSTEM

(71) Applicant: Caterpillar Paving Products Inc., Brooklyn Park, MN (US)

(72) Inventors: John Lee MARSOLEK, Watertown, MN (US); Eric S. ENGELMANN, Delano, MN (US)

(73) Assignee: CATERPILLAR PAVING PRODUCTS INC., Brooklyn Park, MN (US)

(21) Appl. No.: 14/796,830

(22) Filed: Jul. 10, 2015

(51) Int. Cl. G07C 5/08; E01C 23/12; G08B 21/18; E01C 23/088

(52) U.S. Cl. CPC G07C 5/085; E01C 23/088; E01C 23/127; G07C 5/0816; G07C 5/0808; G08B 21/187; G08B 21/182

(57) ABSTRACT

A monitoring system for at least one cutting bit connectable to a milling drum of a machine is disclosed. The monitoring system may include at least one transmitter disposed within the at least one cutting bit and configured to emit a signal associated with the at least one cutting bit. The monitoring system may further include a reader configured to detect the signal emitted by the at least one transmitter, and a controller electronically connected to the reader. The controller may be configured to determine that the at least one cutting bit is connected to the milling drum based on the signal emitted by the at least one transmitter, and determine when a wear level of the at least one cutting bit exceeds a threshold based on the signal emitted by the at least one transmitter.

### TECHNICAL FIELD

The present disclosure relates generally to a monitoring system and, more particularly, to a cutting bit monitoring system.

### BACKGROUND

Asphalt-surfaced roadways are built to facilitate vehicular travel. Depending upon usage density, base conditions, temperature variation, moisture levels, and/or physical age, the surfaces of the roadways eventually become misshapen and unable to support wheel loads. In order to rehabilitate the roadways for continued vehicular use, spent asphalt is removed in preparation for resurfacing.

Cold planers, sometimes also called road mills or scarifiers, are used to break up and remove layers of an asphalt roadway. A cold planer typically includes a frame propelled by tracked or wheeled drive units. The frame supports an engine, an operator's station, a milling drum, and conveyors. The milling drum, fitted with cutting tools, is rotated through a suitable interface with the engine to break up the surface of the roadway. The broken up roadway material is deposited by the milling drum onto the conveyors, which transfer the broken up material into haul trucks for removal from the worksite.

The cutting tools fitted to the milling drum can wear out over time and/or break during milling operations, necessitating their periodic replacement. Operators typically monitor the wearing and breakage of cutting tools by visually inspecting each cutting tool on the milling drum at the beginning and end of each operation and/or during downtime. Depending on the type of material being milled, the cutting depth, and other factors, cutting tools may be inspected and replaced every hour, every few hours, every shift, daily, etc., to ensure that broken and worn out cutting tools are replaced before other cold planer components can be damaged or the milling quality decreases. This inspection and replacement process requires the milling operation to be paused and can consume valuable production time. The subjective nature of the inspection process can also lead to the premature replacement of some cutting tools out of caution or the delayed replacement and breakage of others in an effort to maximize the lifespan of each cutting tool.

One attempt to monitor the wearing of a cutting tool is disclosed in U.S. Patent Application Publication No. 2013/0256032 A1 of Palmer that published on Oct. 3, 2013 (“the '032 publication”). In particular, the '032 publication discloses a wear indication system for a downhole abrading tool that detects signals emitted from a number of tags disposed within the cutting end of the tool. Different types of tags that emit different signals are disposed at various locations within an abrading matrix at the cutting end of the tool. A sensor detects changes in the signals emitted by the various tags as they become dislodged or destroyed during the drilling process. An indication of wear based on the change in signals from the various tags is communicated to an operator via a relay device.

While the system of the '032 publication may allow the wear level of a cutting tool to be monitored, it may not be optimum. In particular, the system of the '032 publication may cause the abrading tool to wear out more quickly since each tag occupies space within the abrading matrix. Additionally, the use of multiple types of tags to indicate wear characteristics may be too complex and/or cost prohibitive for use in systems having multiple cutting tools.

The cutting tool monitoring system of the present disclosure solves one or more of the problems set forth above and/or other problems in the art.

### SUMMARY

In one aspect, the present disclosure is related to a monitoring system for at least one cutting bit connectable to a milling drum of a machine. The monitoring system may include at least one transmitter disposed within the at least one cutting bit and configured to emit a signal associated with the at least one cutting bit. The monitoring system may further include a reader configured to detect the signal emitted by the at least one transmitter, and a controller electronically connected to the reader. The controller may be configured to determine that the at least one cutting bit is connected to the milling drum based on the signal emitted by the at least one transmitter, and determine when a wear level of the at least one cutting bit exceeds a wear threshold based on the signal emitted by the at least one transmitter.

In another aspect, the present disclosure is related to a method of monitoring at least one cutting bit connectable to a milling drum of a machine. The method may include detecting at least one signal emitted by the at least one cutting bit, determining that the at least one cutting bit is connected to the milling drum based on the at least one signal emitted by the at least one cutting bit, and determining when the at least one cutting bit exceeds a wear threshold based on the at least one signal emitted by the at least one cutting bit.

In yet another aspect, the present disclosure is directed to a machine. The machine may include a frame, a traction device connected to the frame and configured to propel the machine, a milling drum connected to the frame, and at least one cutting bit connectable to the milling drum. The machine may further include a first and a second transmitter, each being disposed within the at least one cutting bit and configured to emit a signal associated with the at least one cutting bit, a reader mounted to the frame and configured to detect the signal emitted by the first and second transmitters, and a controller electronically connected to the reader. The controller may be configured to determine that the at least one cutting bit is connected to the milling drum based on the signal emitted by at least one of the first and second transmitters, and determine that a wear level of the at least one cutting bit exceeds a wear threshold when the signal emitted by the first transmitter is detected by the reader and the reader stops detecting the signal emitted by the second transmitter.

### BRIEF DESCRIPTION OF THE DRAWINGS

FIG. 1 is a pictorial illustration of an exemplary disclosed cold planer;

FIG. 2 is a pictorial illustration of exemplary disclosed cutting tools that may be used in conjunction with the cold planer of FIG. 1;

FIGS. 3 and 5 are isometric illustrations of exemplary disclosed cutting bits that may be used with the cutting tools of FIG. 2;

FIGS. 4 and 6 are cross-sectional illustrations of the cutting bits of FIGS. 3 and 5, respectively; and

FIG. 7 is a diagrammatic illustration of an exemplary disclosed monitoring system that may be used with the cold planer of FIG. 1.

### DETAILED DESCRIPTION

For the purpose of this disclosure, the term “asphalt” is defined as a mixture of aggregate and asphalt cement. Asphalt cement is a brownish-black solid or semi-solid mixture of bitumens obtained as a byproduct of petroleum distillation. The asphalt cement can be heated and mixed with the aggregate for use in paving roadway surfaces, where the mixture hardens upon cooling. A “cold planer” is defined as a machine used to remove layers of hardened asphalt from an existing roadway. It is contemplated that the disclosed cold planer may also or alternatively be used to remove cement and other roadway surfaces, or to remove non-roadway surface material such as in a reclaiming or mining operation.

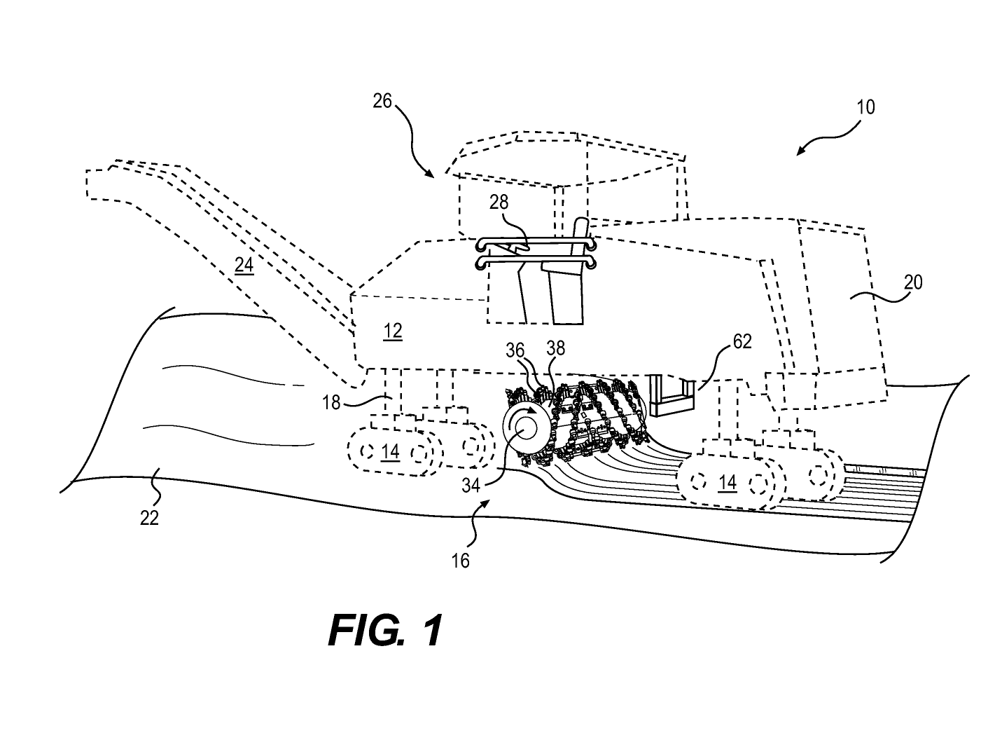

FIG. 1 illustrates an exemplary cold planer 10. Cold planer 10 may include a frame 12 connected to one or more traction units 14, and a milling drum 16 supported from frame 12 at a general center of cold planer 10 between traction units 14. Traction units 14 may each include either a wheel or a track section that is pivotally connected to frame 12 by an actuator 18. Actuators 18 may be adapted to controllably raise, lower, and/or tilt frame 12 relative to the associated traction units 14. It should be noted that, in the disclosed embodiment, raising and lowering of frame 12 may also function to vary a milling depth of milling drum 16 into a work surface 22. An engine 20 (or other power source) may be configured to electrically, mechanically, hydraulically, and/or pneumatically power traction units 14, milling drum 16, and actuators 18. A conveyor system 24 may be pivotally connected at a leading end to frame 12 and configured to transport material away from milling drum 18 and into a transport vehicle.

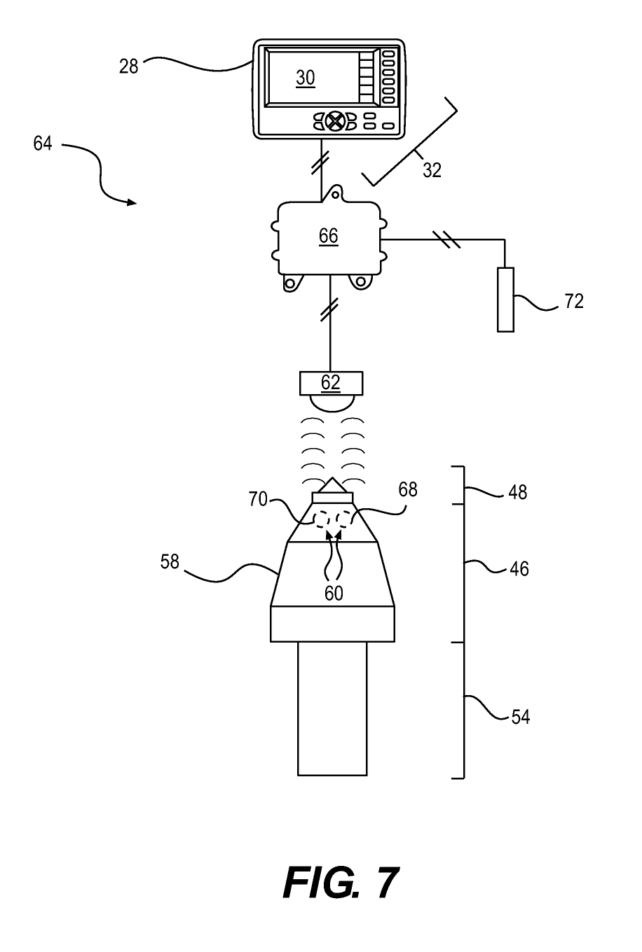

Frame 12 may also support an operator station 26. Operator station 26 may house any number of interface devices 28 used to control cold planer 10. In the disclosed example, interface devices 28 may include, among other things, a display 30, and an input device 32 (30 and 32 shown only in FIG. 7). In other embodiments, operator station 26 may be offboard cold planer 10. For example, operator station 26 may embody a remote control, such as a handheld controller, that an operator may use to control cold planer 10 from anywhere on the worksite. Operator station 26 may alternatively embody a software program and user interface for a computer, and may include a combination of hardware and software. In other embodiments, cold planer 10 may be autonomous and may not include operator station 26.

Display 30 may be configured to render the location of cold planer 10 (e.g., of milling drum 18) relative to features of the jobsite (e.g., milled and/or unmilled parts of work surface 22), and to display data and/or other information to the operator. Input device 32 may be configured to receive data and/or instructions from the operator of cold planer 10. For example, input device 32 may be an analog input device that receives control instructions via one or more buttons, switches, dials, levers, etc. Input device 32 may also or alternatively include digital components, such as one or more soft keys, touch screens, and/or visual displays. Other interface devices (e.g., control devices) may also be possible, and one or more of the interface devices described above could be combined into a single interface device, if desired.

Milling drum 16 may include components rotated by engine 20 to fragment and remove chunks of asphalt and/or other material from work surface 22. Specifically, milling drum 16 may include a rotary head 34 having one or more rows of cutting tools 36 operatively connected to an outer cylindrical surface 38. In the disclosed embodiment, three spiraling rows of cutting tools 36 initiate at each end of rotary head 34 and terminate at a lengthwise center of milling drum 16. It should be noted, however, that a greater or lesser number of cutting tools 36 may be included, if desired.

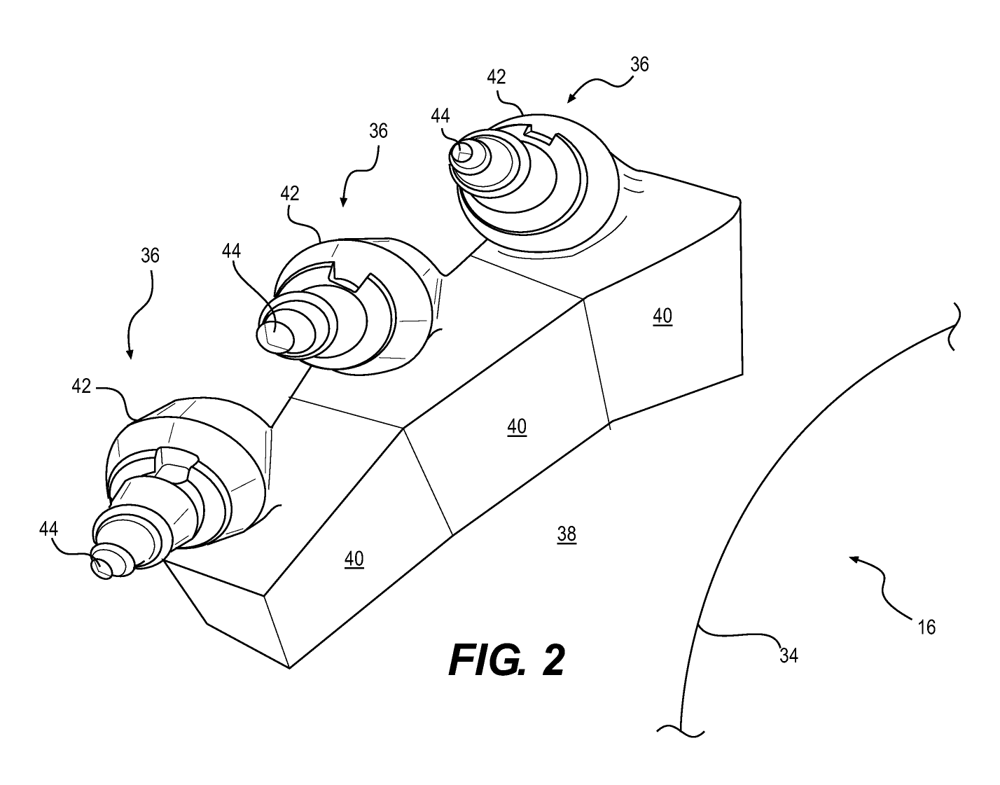

As shown in FIG. 2, each row of cutting tools 36 may be formed by individual mounting blocks 40, tool holders 42, and cutting bits 44. Mounting blocks 40 may be fixedly connected to outer cylindrical surface 38 of rotary head 34, for example by welding, and configured to removably receive tool holders 42. Each tool holder 42, in turn, may be configured to removably receive one cutting bit 44. Each cutting bit 44 may be connectable to a respective tool holder 42 in order to facilitate periodic replacement. In other embodiments, each cutting bit 44 and respective tool holder 42 may be integrally formed as a unitary structure that is connectable to a respective mounting block 40 to facilitate periodic replacement.

Each cutting bit 44 may include a body 46 and a tip 48 that are exposed when cutting bit 44 is connected to tool holder 42. Body 46 may extend outwardly from tool holder 42, and a tip 48 may be connected to an end of body 46, for example, by welding or brazing. Tip 48 may be generally narrower than body 46 and configured to pierce work surface 22, thereby allowing body 46 to penetrate into work surface 22 and break up material. During operation, the cutting depth of milling drum 16 may be set by the operator such that tip 48 and body 46 may penetrate work surface 22, while preventing tool holder 42 and mounting block 40 from directly engaging work surface 22. Thus, cutting bit 44 may experience wear and be periodically changed when a wear level of cutting bit 44 exceeds a threshold, while tool holder 42 and mounting block 40, which may be more expensive and require more time replace than cutting bit 44, may be preserved for prolonged use. In this way, the overall cost of operating milling drum 16 and the downtime associated with repairs may be reduced.

Tip 48 may be made of a harder material than body 46 to help reduce wear and preserve the ability of cutting bit 44 to effectively pierce work surface 22 over time. For example, tip 48 may comprise steel carbide, a diamond compound, or another hard metal or non-metal material. Because these materials may be generally more expensive than other possible materials, body 46 may comprise a less expensive material that is less resistive to wear than tip 48. For example, body 46 may comprise a steel alloy, steel carbide, or another metal or non-metal material. Body 46 may be generally bulkier than tip 48 to help increase the longevity of body 46 as it experiences wear during operation.

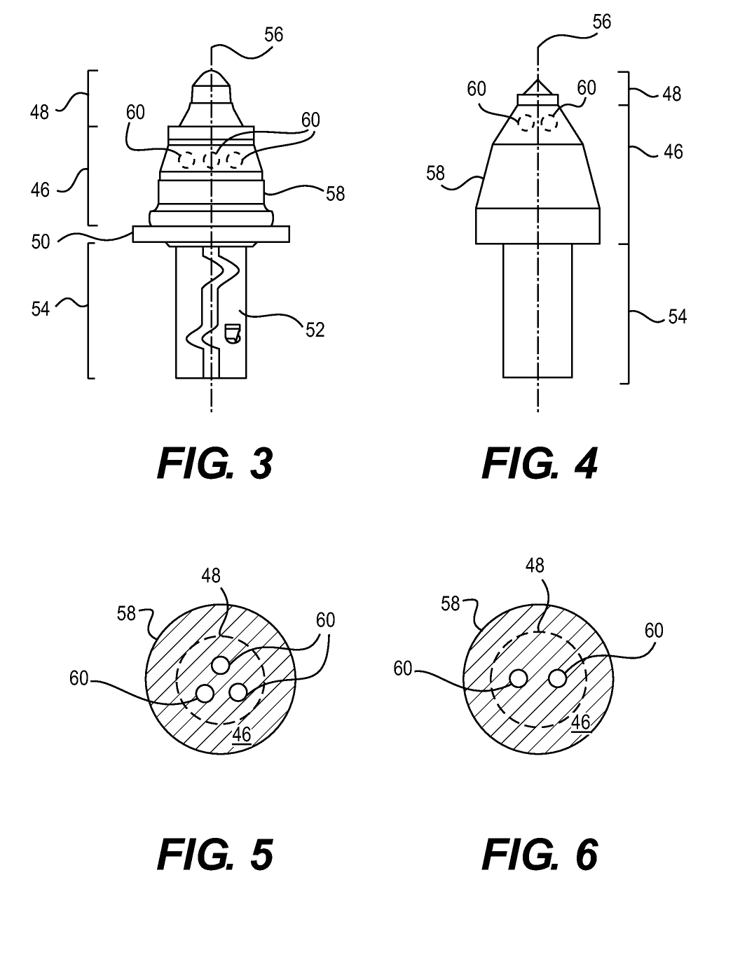

As shown in FIG. 3, cutting bit 44 may include components that cooperate with tool holder 42 (referring to FIG. 2) to allow cutting bit to rotate within tool holder 42 during operation. For example, cutting bit 44 may include a washer 50 and a spring clip 52 connected to a shank 54 of cutting bit 44. For purposes of this description, shank 54 may be a portion of cutting bit that is configured to be inserted into tool holder 42 or into mounting block 40 (e.g., when cutting bit and tool holder 42 are one unitary structure.). When shank 54 is inserted into tool holder 42, spring clip 52 may hold shank within tool holder 42, and tool holder 42 may be configured to allow cutting bit to rotate about a central axis 56.

During operation, tip 48 and body 46 may engage work surface 22, causing cutting bit 44 to rotate about central axis 56 so that body 46 may wear evenly about central axis 56. That is, body 46 may gradually wear such that at any given instant, an outer surface 58 of body 46 may wear by the same amount at each point around central axis 56. In some situations, however, cutting bit 44 can experience accelerated wear on one portion of outer surface 58, while other portions wear less quickly or not at all.

For example, when cutting bit 44 is prevented from rotating within tool holder 42, a forward facing portion of outer surface 58 may experience significant wear, while other portions are prevented from directly engaging work surface 22. In other situations, accelerated wearing of outer surface 58 may occur after cutting bit 44 strikes a hard object, such as a manhole cover, a water or gas valve, etc., causing tip 48 and/or a portion of body 46 to break off. After a portion of body 46 wears beyond a threshold amount, washer 50, tool holder (referring to FIG. 2), and/or mounting block 40 may begin to wear, which can decrease the quality of the milling pattern created by milling drum 16 and incur additional costs to replace each worn component.

To help detect when cutting bit 44 exceeds the wear threshold, cutting bit 44 may be configured to emit at least one signal via at least one transmitter 60 disposed within cutting bit 44. Transmitters 60 may be a sacrificial components disposed within body 46 of cutting bit 44 at a depth below outer surface 58 such that transmitters 60 remain intact and emit a signal until cutting bit 44 exceeds the wear threshold. When cutting bit 44 exceeds the wear threshold (i.e., when body 46 wears to a certain depth below outer surface 58), transmitters 60 may become exposed. Once exposed, transmitters 60 may be destroyed and stop emitting signals or fall out of cutting bit 44. Transmitters 60 may be disposed within cutting bit, for example, by drilling a hole into body 46 for each transmitter, inserting each transmitter into the hold, and filling the hold with an epoxy or other filling material. It is understood that other ways of disposing transmitters 60 within cutting bits 44 may be possible.

In one embodiment, as shown in FIG. 4, each transmitter 60 may be disposed within body 46 at the same depth below outer surface 58 to allow each transmitter to be exposed after the same amount of wear has been experienced on a respective portion of cutting bit 44. For example, as cutting bit 44 (referring to FIG. 3) rotates within tool holder (referring to FIG. 2) during operation of milling drum 16, each transmitter 60 may remain intact until the portion of body 46 in which it is located exceeds the wear threshold. In this way, at least one transmitter may be sacrificed when cutter bit reaches the wear threshold.

Additionally, each transmitter 60 may be positioned within cutting bit 44 such that at least one transmitter 60 may be sacrificed when cutting bit 44 exceeds the wear threshold even when cutting bit 44 is prevented from rotating within tool holder 42. That is, one or more transmitters 60 may be disposed within body 46 such that at least one transmitter 60 is sacrificed when cutting bit 44 exceeds the wear threshold regardless of which portion of body 46 wears most quickly when cutting bit 44 stops rotating. For example, a number of transmitters 60 may be evenly spaced within body 46 and centered about central axis 56. Although three transmitters 60 are shown in FIG. 4, fewer or more transmitters 60 may be used, if desired. Transmitters 60 may be equidistant from central axis 56, equidistant from adjacent transmitters 60, and/or symmetrically spaced about central axis 56.

In another embodiment, as shown in FIG. 5, cutting bit 44 may be configured for fixed insertion into tool holder 42 (referring to FIG. 2) or mounting block 40. Once inserted, cutting bit 44 may be secured via a pin, bolt, clip, (not shown) or other fastening technique and may not be allowed to rotate about central axis 56. In this way, certain predictable portions of body 46 may experience greater wear than others during operation. Thus, cutting bit 44 of FIG. 5 may include one or more transmitters 60 that are positioned in locations that are likely to experience wear the fastest. By placing transmitters 60 in only certain locations that are likely to wear more quickly than others, fewer transmitters 60 may be used and the cost of cutting bit 44 may be reduced.

As shown in FIG. 6, cutting bit 44 of FIG. 5 may, for example, include only two transmitters 60 positioned at locations within body 46 that may be likely to wear most quickly. It is understood, however, that fewer or more transmitters 60 may be used, if desired. Transmitters 60 may be spaced radially outward from central axis 56 by the same distance to allow each transmitter 60 to be exposed when cutting bit 44 exceeds the wear threshold.

Each transmitter 60 may be configured to emit a signal that is associated with cutting bit 44. For example, transmitter 60 may be a radio frequency identification (RFID) tag that emits a signal indicative of an ID. In one embodiment, the ID of each transmitter 60 within cutting bit 44 may be unique and individually associated with cutting bit 44. In another embodiment, the ID of each transmitter 60 may be the same and commonly associated with cutting bit 44. Transmitter 60 may be another type of transmitter capable of generating a signal from within cutting bit 44, if desired.

Referring again to FIG. 1, cold planer 10 may include a reader 62 that is configured to detect the signal emitted by each transmitter 60 disposed within each cutting bit 44 (referring to FIG. 2) attached to milling drum 16. For example, reader 62 may be an RFID tag reader. It is understood, however, that reader 62 may be another type of reader configured to detect different types of signals, if desired. Reader 62 may be positioned within a distance of milling drum 16 that allows the signal from each transmitter 60 disposed within each respective cutting bit 44 to be detected when cutting bit 44 is connected to milling drum 16. For example, reader 62 may be connected to cold planer 10 at a location adjacent milling drum 16. Although reader 62 is shown in FIG. 1 as being connected to frame 12, reader 62 may alternatively be connected to other components of cold planer 10, if desired.

Referring to FIG. 7, a cutting bit monitoring system 64 (“monitoring system”) may be associated with cold planer 10 and include elements that cooperate to help determine when each cutting bit 44 exceeds the wear threshold, breaks, or becomes disconnected from milling drum 16 (referring to FIG. 1) based on the signals emitted by each transmitter 60 disposed within each cutting bit 44. Elements of monitoring system 64 may include interface devices 28, at least one transmitter 60, reader 62, and a controller 66 electronically connected with each of the other elements. Reader 62 may detect the signal emitted by each transmitter 60 disposed within each cutting bit 44 and communicate each detected signal to controller 66. Controller 66 may determine and store information about each cutting bit 44 based on the signals received from reader 62. Controller 66 may also generate warnings based on the signals and show the warnings to the operator of cold planer 10 via display 30. Although FIG. 7 shows a single cutting bit 44, it should be noted that monitoring system 64 may interact in the same way with each of the plurality of cutting bits 44 connectable to milling drum 16 (referring to FIG. 1).

Controller 66 may embody a single microprocessor or multiple microprocessors that include a means for monitoring operator and sensor input, and responsively adjusting operational characteristics of cold planer 10 based on the input. For example, controller 66 may include a memory, a secondary storage device, a clock, and a processor, such as a central processing unit or any other means for accomplishing a task consistent with the present disclosure. Numerous commercially available microprocessors can be configured to perform the functions of controller 66. It should be appreciated that controller 66 could readily embody a general machine controller capable of controlling numerous other machine functions. Various other known circuits may be associated with controller 66, including signal-conditioning circuitry, communication circuitry, and other appropriate circuitry. Controller 66 may be further communicatively coupled with an external computer system, instead of or in addition to including a computer system, as desired.

Controller 66 may be configured to determine when cutting bit 44 is connected to milling drum 16 (referring to FIG. 1) based on the signal emitted by at least one transmitter 60 disposed within cutting bit 44. That is, each transmitter 60 may emit a signal indicative of an ID associated with cutting bit 44, and controller 66 may determine that cutting bit 44 is connected to milling drum 16 when reader 62 detects at least one signal indicative of an ID associated with cutting bit 44. For example, in embodiments where transmitters 60 each emit a signal indicative of a unique ID, controller 66 may be configured to determine that the unique IDs of transmitters 60 are associated with each other and/or with cutting bit 44 once detected by reader 62. When at least one associated ID is detected by reader 62, controller 66 may determine that cutting bit 44 is connected to milling drum 16. In embodiments where transmitters 60 each emit a signal indicative of the same ID, controller 66 may determine that cutting bit 44 is connected to milling drum 16 when a signal indicative of the ID is detected.

Controller 66 may automatically determine when a new cutting bit 44 is connected to milling drum 16. For example, reader 62 may detect the signal emitted by each transmitter 60 once a new cutting bit 44 is connected to milling drum 16 and record in its memory the ID indicated by each new signal. Controller 66 may then monitor cutting bit 44 by monitoring the signal emitted by each transmitter 60 and determining whether the signal (or signals) indicative of each stored ID is still being detected by reader 62. In other embodiments, each new cutting bit 44 may be logged into the memory of controller 66 manually by the operator. For example, monitoring system may include a scanning device in communication with controller 66 that is configured to detect and/or assign an ID to the signal emitted by each transmitter 60 within cutting bit 44 before cutting bit 44 is connected to milling drum 16. Alternatively, IDs may be entered via input device 32 and communicated to controller 66.

After a new cutting bit 44 is connected to milling drum 16, controller 66 may be configured to monitor cutting bit 44 and determine when at least one signal indicative of an ID associated with cutting bit 44 is no longer detected by reader 62. For example, when the signal emitted by at least one transmitter 60 associated with cutting bit 44 is not detected by reader 62, cutting bit 44 may no longer be connected to milling drum 16 or may require replacement due to damage or wearing. That is, for example, when cutting bit 44 is ejected from tool holder 42 (referring to FIG. 2), when body 46 breaks away from shank 54, or when each transmitter 60 has been lost or destroyed due to wearing of body 46, reader 62 may no longer be able to detect signals from transmitters 60. When reader 62 no longer detects signals emitted by at least one transmitter 60 disposed within cutting bit 44, controller 66 may determine that cutting bit 44 should be replaced and generate a first warning.

The first warning generated by controller 66 may be indicative of a request to replace cutting bit 44. For example, the first warning may include a visual indication (e.g., using words, letters, numbers, flashing lights, etc.) That cutting bit 44 is no longer detected and should be replaced. In some embodiments, the first warning may be a general warning that cutting bit 44 should be replaced. In other embodiments, controller 66 may help identify cutting bit 44 by communicating the stored ID indicated by the signal (now no longer detected) of at least one transmitter 60 associated with cutting bit 44 when generating the first signal.

The first warning may also or alternatively indicate a position of cutting bit 44 on milling drum 16. For example, when at least one transmitter 60 is detected by reader 62, controller 66 may be configured to determine where on milling drum 16 cutting bit 44 is located (e.g., left side, center, right side, etc.) based on signal strength and/or the detection of associated signals. Controller 66 may store the location within its memory and access the stored location when generating the first warning. Controller 66 may be configured to show or otherwise communicate the first warning and/or the location of cutting bit 44 to the operator of cold planer 10 via display 30. In this way, the operator of cold planer 10 may be quickly notified when cutting bit 44 should be replaced to avoid reductions in milling quality and/or further damage to milling drum 16.

Controller 66 may be also be configured to determine when cutting bit 44 exceeds the wear threshold based on the signal emitted by each transmitter 60. For example, any time reader 62 stops detecting the signal from a first transmitter 68 associated with cutting bit 44, controller 66 may then determine whether the signal emitted by at least a second transmitter 70 is detected by reader 62. When the signal from the at least second transmitter 70 is detected, controller 66 may determine that cutting bit 44 is still connected to milling drum 16 and that at least a portion of cutting bit 44 has exceeded the wear threshold. In this way, controller 66 may monitor the same signals that are used to generate the first warning to also indicate when cutting bit 44 exceeds the wear threshold. Thus, monitoring system 64 may be simplified in design and incur lower production costs while being able to monitor multiple facets of cutting bit 44.

Controller 66 may be configured to generate a second warning when it determines that cutting bit 44 has exceeded the wear threshold. The second warning may be indicative of a request to inspect cutting bit 44 at the operator's next convenient opportunity. That is, when cutting bit 44 reaches the wear threshold, operation using cutting bit 44 may be able to continue for a period of time to allow for a more efficient overall milling operation. For example, the operator may wish to continue the milling operation until a convenient opportunity arises to fully stop the milling operation, such as during a shift break, a shift change, when an empty transport truck is approaching, at the end of the day, etc. At such a time, the operator may be able to inspect cutting bit 44 and determine whether to replace it or allow the operation to continue for an extended period of time, for example, until the end of a subsequent shift or until the end of the day. In this way, use of each cutting bit 44 may be extended, thereby partially reducing the overall cost of the milling operation.

Controller 66 may be configured to show the second warning to the operator via display 30. For example, the second warning may include a visual indication (e.g., using words, letters, numbers, flashing lights, etc.) That cutting bit 44 has exceeded the wear threshold and should be inspected. In some embodiments, the second warning may be a general warning that cutting bit 44 should be inspected. In other embodiments, controller 66 may help identify cutting bit 44 by communicating the ID indicated by the signal of at least one transmitter 60 associated with cutting bit 44 when generating the second signal. As described with regard to the first warning, controller 66 may be configured to communicate a location of cutting bit 44 with the second warning to facilitate a speedy replacement.

To help operators and worksite managers plan inspections of milling drum 16 and to better assess the costs associated with operating cold planer 10, controller 66 may be configured to track a time elapsed T_{E} after cutting bit 44 is connected to milling drum 16 until it exceeds the wear threshold or should be replaced. For example, controller 66 may begin tracking the time elapsed T_{E} after cutting bit 44 is connected to milling drum 16, and record a current date and/or time within its memory (e.g., via an electronic timestamp). The elapsed time T_{E} and/or timestamp may be recorded for each transmitter 60 disposed within cutting bit 44 and associated with the respective ID indicated by each signal. In this way, operators and managers may be able to access the stored information at the end of a shift, day, or other period of time and estimate whether any cutting bits 44 may need to be changed in the near future.

When the signal emitted by a respective transmitter 60 stops being detected by reader 62 (e.g., when a first or second warning is generated), controller 66 may be configured to record the elapsed time T_{E} and/or timestamp and associate it with the ID indicated by the signal emitted by the respective transmitter 60. In this way, controller 66 may store in its memory the elapsed time T_{E} and/or specific time at which each transmitter 60 disposed within cutting bit 44 stops being detected. Controller 66 may also record the type of warning that is generated when each signal stops being detected and associate the ID of the respective transmitter 60 with the type of warning. In this way, controller 66 may store information about the failure mode of cutting bit 44. The information stored within the memory of controller 66 may be accessed by operators and managers to assess the performance of cutting bit 44.

Controller 66 may also be configured to determine a lifespan of cutting bit 44 based on the elapsed time T_{E} after cutting bit 44 was connected to milling drum 16. For example, monitoring system 64 may include a number of sensors 72 disposed throughout cold planer 10. Sensors 72 may be configured to generate signals indicative of operating parameters, such as a rotational speed ω of milling drum 16, a depth D of milling drum 16 below work surface 22, a groundspeed V of cold planer 10, and/or other parameters. Controller 66 may be configured to associate the elapsed time T_{E} with at least one sensed parameter to determine an amount of time that cutting bit 44 engaged work surface 22 to determine a work time T_{w} of cutting bit 44. For instance, when the rotational speed ω and depth D of milling drum 16 as well as the groundspeed V of cold planer 10 each have a non-zero value, cutting bit 44 may be engaged with work surface 22 and experiencing wear. It is understood that other ways of determining when cutting bit 44 is engaged with work surface 22 may be possible.

Controller 66 may be configured to associate the work time T_{w} of cutting bit 44 with the ID indicated by a respective transmitter 60 each time a signal stops being detected by reader 62 (e.g., when a first or second warning is generated). In this way, controller 66 may be configured to determine and record how long cutting bit 44 can be used during operation before it exceeds the wear threshold, breaks, falls out, etc. Such data may be collected for each cutting tool 44 disposed on milling drum 16. The work time T_{w} may be regarded as the lifespan of cutting bit 44 either when cutting bit 44 exceeds the wear threshold or when it ultimately fails or is removed (i.e., when reader 62 no longer detects the signal emitted by at least one transmitter 60 within cutting bit 44). Operators and managers may be able to access this data stored within the memory of controller 66 for future analysis of operating costs and productivity.

### INDUSTRIAL APPLICABILITY

The disclosed monitoring system may be used with any cold planer where determining the loss and/or wearing out of cutting bits is important. The disclosed monitoring system may determine when each cutting bit is connected to a milling drum, when it exceeds a wear threshold, and/or when it breaks or falls out of the milling drum. A controller within the system may provide warnings to an operator each time a cutting bit wears out or is no longer detected. The controller may also record the lifespan and failure mode of each cutting bit for future cost and productivity analysis. Operation of monitoring system 64 will now be explained.

When cold planer 10 is at rest (e.g., before a milling operation starts, during a break in the operation, etc.), a new cutting bit 44 may be inserted into tool holder 42 of milling drum 16. When the milling operation is resumed, reader 62 may detect the signal generated by at least one transmitter 60 disposed within cutting bit 44. Each signal may be indicative of an ID associated with cutting bit 44. Upon detection of each signal, controller 66 may record each respective ID within its memory and begin to track the time elapsed T_{E} since the connection of cutting bit 44. Controller 66 may also record a timestamp upon detection of each signal and associate the elapsed time T_{E} and timestamp with the respective ID of each signal.

During operation, cutting bit 44 may engage work surface 22. Controller 66 may determine when cutting bit 44 is engaged to work surface 22 based on signals generated by sensors 72, which may be indicative of, among other parameters, the rotational speed ω of milling drum 16, the depth D of milling drum 16 below work surface 22, and the groundspeed V of cold planer 10. Controller 66 may continually track the elapsed time T_{E} in coordination with these parameters and determine a work time T_{w} of cutting bit 44. Controller 66 may store the work time T_{w} within its memory for use during future processing.

As operation of cold planer 10 continues, controller 66 may monitor the signal generated by each transmitter 60 disposed within cutting bit 44. Controller 66 may generate a warning whenever the signal generated by a respective transmitter 60 stops being detected by reader 62. For example, when cutting bit 44 is ejected from tool holder 42, when body 46 breaks away from shank 54, or when each transmitter 60 has been lost or destroyed due to wearing of body 46, reader 62 may no longer be able to detect signals from transmitters 60. When reader 62 no longer detects the signal from at least one transmitter 60 disposed within cutting bit 44, controller 66 may determine that cutting bit 44 should be replaced and generate a first warning. The first warning may be indicative of a request to replace cutting bit 44 at the operator's earliest convenience. Controller 66 may show the first signal to the operator via display 30.

When reader 62 stops detecting the signal from first transmitter 68 associated with cutting bit 44, controller 66 may determine whether the signal emitted by at least second transmitter 70 is detected by reader 62. When the signal emitted by second transmitter 70 is detected, controller 66 may determine that cutting bit 44 is still connected to milling drum 16 and that at least a portion of cutting bit 44 has exceeded the wear threshold. Controller 66 may then generate a second warning and show it to the operator via display 30. The second warning may be indicative of a request to inspect cutting bit 44 at the operator's next convenient opportunity, such as during a shift break, a shift change, when an empty transport truck is approaching, at the end of the day, etc.

Each time the first and/or second warning is generated, controller 66 may record the elapsed time T_{E}, timestamp, type of warning that was generated (e.g., first or second), and work time T_{w} and store this data in its memory. This data may be associated with the ID indicated by the signal that stopped being detected by reader 62. The work time T_{w} recorded by controller 66 when the signal emitted by at least one transmitter 60 disposed within cutting bit 44 is no longer detected by reader 62 may be regarded as the lifespan of cutting bit 44.

During operation, controller 66 may determine where on milling drum 16 cutting bit 44 is located (e.g., based on the strength of the signal emitted by transmitters 60) and store the location in its memory (e.g., in association with the ID of the respective signal). Each time the first and/or second warning is generated, controller 66 may communicate the stored location of the respective cutting bit 44 to the operator via the first and/or second signal. Controller 66 may show the first warning to the operator of cold planer 10 via display 30. In this way, the operator of cold planer 10 may be quickly notified when cutting bit 44 should be replaced to avoid reductions in milling quality and/or further damage to milling drum 16.

Several advantages may be associated with the disclosed monitoring system. For example, because controller 66 may determine whether cutting bit 44 is connected to milling drum 16 and when cutting bit 44 reaches the wear threshold based on the same signals emitted by transmitters 60, monitoring system 64 may be less complex and less costly to implement. Further, because transmitters 60 may be used to indicate multiple facets of cutting bit 44, fewer transmitters 60 may be disposed within cutting bit 44, thereby reducing void spaces within body 46 and improving the lifespan of cutting bit 44. Additionally, because controller 66 may generate warnings when cutting bit 44 exceeds the wear threshold and when cutting bit 44 is no longer detected, operators may be allowed to decide when is most convenient and cost effective to replace cutting bit 44. Further, because controller 66 may provide data about the lifespan of cutting bit 44, operators and managers may be able to analyze the data to plan more efficient milling operations.

It will be apparent to those skilled in the art that various modifications and variations can be made to the disclosed monitoring system without departing from the scope of the disclosure. Other embodiments of the monitoring system will be apparent to those skilled in the art from consideration of the specification and practice of the monitoring system disclosed herein. It is intended that the specification and examples be considered as exemplary only, with a true scope of the disclosure being indicated by the following claims and their equivalents.

What is claimed is:

1. A monitoring system for at least one cutting bit connectable to a milling drum of a machine, the monitoring system comprising:
at least one transmitter disposed within the at least one cutting bit and configured to emit a signal associated with the at least one cutting bit;
a reader configured to detect the signal emitted by the at least one transmitter;
a controller electronically connected to the reader and configured to:
determine that the at least one cutting bit is connected to the milling drum based on the signal emitted by the at least one transmitter; and
determine when the at least one cutting bit exceeds a wear threshold based on the signal emitted by the at least one transmitter.

2. The monitoring system of claim 1, wherein the controller is configured to determine that the at least one cutting bit is connected to the milling drum when the signal emitted by the at least one transmitter is detected by the reader.

3. The monitoring system of claim 2, wherein the controller is configured to generate a first warning indicative of a request to replace the at least one cutting bit when the reader stops detecting the signal emitted by the at least one transmitter.

4. The monitoring system of claim 3, wherein:
the monitoring system further includes at least a second transmitter disposed within the cutting bit and configured to emit a signal associated with the at least one cutting bit; and
the controller is configured to determine that the at least one cutting bit exceeds the wear threshold when the signal emitted by the at least one transmitter is detected by the reader and the reader stops detecting the signal emitted by the at least second transmitter.

5. The monitoring system of claim 4, wherein the controller is configured to generate a second warning indicative of a request to inspect the at least one cutting bit when the at least one cutting bit exceeds the wear threshold.

6. The monitoring system of claim 5, further including a display electronically connected to the controller, wherein the controller is configured to show at least one of the first and second warnings to an operator of the machine via the display.

7. The monitoring system of claim 6, wherein the controller is further configured to:
determine a location of the at least one cutting bit based on the at least one signal; and
communicate the location of the at least one cutting bit to the operator of the machine via the display

8. The monitoring system of claim 1, wherein the signal emitted by the at least one transmitter is indicative of an ID, and the controller is configured to:
track a time elapsed after the at least one cutting bit is connected to the milling drum;
record the elapsed time when the reader stops detecting the signal emitted by the at least one transmitter; and
associate the elapsed time with the ID.

9. The monitoring system of claim 8, wherein the controller is configured to determine a lifespan of the cutting bit based on the elapsed time and associate the lifespan with the ID.

10. The monitoring system of claim 9, wherein the controller is configured to determine the lifespan of the cutting bit based further on at least one of a speed of the milling drum, a depth of the milling drum, and a groundspeed of the machine.

11. A method of monitoring at least one cutting bit connectable to a milling drum of a machine, the method comprising:
detecting at least one signal emitted by the at least one cutting bit;
determining that the at least one cutting bit is connected to the milling drum based on the at least one signal emitted by the at least one cutting bit; and
determining when the at least one cutting bit exceeds a wear threshold based on the at least one signal emitted by the at least one cutting bit.

12. The method of claim 11, further including determining that the at least one cutting bit is connected to the milling drum when the signal emitted by the at least one cutting bit is detected.

13. The method of claim 12, further including generating a first warning indicative of a request to replace the at least one cutting bit when the at least one signal emitted by the at least one cutting bit stops being detected.

14. The method of claim 13, further including:
detecting at least a second signal emitted by the at least one cutting bit; and
determining that the at least one cutting bit exceeds the wear the threshold when the at least one signal is detected and the at least second signal stops being detected.

15. The method of claim 14, further including generating a second warning indicative of a request to inspect the at least one cutting bit when the at least one cutting bit exceeds the wear threshold.

16. The method of claim 15, further including showing at least one of the first and second warnings to an operator of the machine via a display.

17. The method of claim 16, further including:
determining a location of the at least one cutting bit based on the at least one signal; and
communicating the location of the at least one cutting bit to the operator of the machine via the display.

18. The method of claim 11, wherein the at least one signal emitted by the at least one cutting bit is indicative of an ID, and the method further includes:
tracking a time elapsed after the at least one cutting bit is connected to the milling drum;
recording the elapsed time when the at least one signal emitted by the at least one cutting bit stops being detected; and
associating the elapsed time with the ID.

19. The method of claim 18, further including:
determining a lifespan of the at least one cutting bit based on the elapsed time and at least one of a speed of the milling drum, a depth of the milling drum, and a groundspeed of the machine; and
associating the lifespan of the at least one cutting bit with the ID.

20. A machine comprising:
a frame;
a fraction device connected to the frame and configured to propel the machine;
a milling drum connected to the frame;
at least one cutting bit connectable to the milling drum;
a first and a second transmitter, each being disposed within the at least one cutting bit and configured to emit a signal associated with the at least one cutting bit;
a reader mounted to the frame and configured to detect the signal emitted by the first and second transmitters; and
a controller electronically connected to the reader and configured to:
determine that the at least one cutting bit is connected to the milling drum based on the signal emitted by at least one of the first and second transmitters; and
determine that the at least one cutting bit exceeds a wear threshold when the signal emitted by the first transmitter is detected by the reader and the reader stops detecting the signal emitted by the second transmitter.
